(19) United States
(12) Patent Application Publication
(10) Pub. No.: US 2022/0258501 A1
(43) Pub. Date: Aug. 18, 2022

(54) CARRIAGE ACTIVATED PRINTING DEVICES

(71) Applicant: Hewlett-Packard Development Company, L.P., Spring, TX (US)

(72) Inventors: Seng San Koh, Singapore (SG); KOK CHAI CHONG, Singapore (SG); Siew Hong Lam, Singapore (SG); TONG NAM SAMUEL LOW, Singapore (SG)

(73) Assignee: Hewlett-Packard Development Company, L.P., Spring, TX (US)

(21) Appl. No.: 17/630,732

(22) PCT Filed: Aug. 19, 2019
(86) PCT No.: PCT/US2019/046994

§ 371 Date: Jan. 27, 2022

(51) Int. Cl. B41J 19/20; B41J 29/38; B33Y 30/00; B29C 64/236

(52) U.S. Cl. CPC B41J 19/20; B29C 64/236; B33Y 30/00; B41J 29/38

(57) ABSTRACT

In one example, a printing device may include a first motor to transition a carriage between a first position and a second position, the carriage to exert a force on a gate shifter as the carriage transitions between the first position and the second position, the gate shifter to transition between an open position and a closed position in response to the exerted force of the carriage, and a feed swingarm to transition between a first side and a second side of the gate shifter when the gate shifter is in the open position.

### BACKGROUND

Printing devices, such as scanning printers, page wide printers, copiers, or the like, may generate text or images on to print media (e.g., paper, plastic, or the like). Printing devices may utilize a print substance that may be deposited on to the print media to generate the text or images on the print media. Printing devices may transition print media to a print zone to deposit print substance on to print media.

### BRIEF DESCRIPTION OF THE DRAWINGS

FIG. 1 is an example carriage activated printing device in a closed position consistent with the present disclosure.

FIG. 2 is an example method for a carriage activated printing device consistent with the present disclosure.

FIG. 3 is an example system for a carriage activated printing device in an open position consistent with the present disclosure.

FIG. 4 is an example carriage activated printing device in an active position consistent with the present disclosure.

FIG. 5 is an example method for a carriage activated printing device consistent with the present disclosure.

### DETAILED DESCRIPTION

Carriage activated printing device and systems are described herein. As used herein, “printing device” refers to a hardware device with functionalities to physically produce representation(s) of text, images, models, or the like on a print medium or produce a three-dimensional object. Examples of printing devices include ink/toner printers or three-dimensional printers, among other types of printing devices. Some printing devices may include a first motor to transition a carriage, a second motor to actuate a pick mechanism, and a third motor to actuate a print media feed component. That is, some printing devices may utilize three or more motors to actuate a carriage, a print media feed component, and a pick mechanism. However, an increased number of motors (e.g., three or more motors) included in the printing device may reduce the available space in the printing device and/or cause the printing device to increase in size to accommodate the increased number of motors, as compared to printing device with the same functionalities that utilizes two or less motors. In addition, utilizing three or more motors to actuate the carriage, the print media feed component, and the pick mechanism may increase the cost of the printing device, as compared to a printing device that utilizes two or less motors. That is, increasing the number of motors in a printing device may increase the size of the printing device and/or increase the cost of producing the printing device.

This disclosure describes carriage activated printing devices that utilize two motors to actuate a carriage, a print media feed component, and the pick mechanism. For example, the printing device may include a first motor to transition a carriage between a first position and a second position. The carriage may exert a force on a gate shifter to cause the gate shifter to open and close. In addition, the printing device may include a second motor to transition a feed swingarm through an opening in the gate shifter. Utilizing two motors to actuate a carriage, a print media feed component, and a pick mechanism may allow for a smaller more compact printing device with increased function, as compared to a printing device that utilizes three motors to actuate the carriage, the print media feed component, and the pick mechanism. Producing compact printing devices may increase performance of the printing device and reduce the cost of producing the printing device while maintaining a plurality of functions. For instance, with less than three motors the printing device is able to control and actuate three different components of the printing device (e.g., the carriage, the print media feed component, and the pick mechanism).

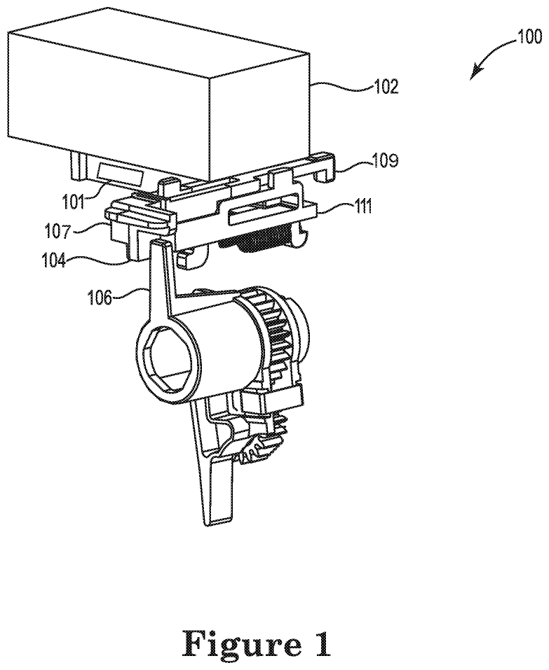

FIG. 1 is an example carriage activated printing device 100 in a closed position consistent with the present disclosure. It should be understood that even though examples herein describe motors being utilized to provide functions to the carriage, pick mechanism, and feed component, the disclosure is not limited to these functions and the systems described herein may be utilized to provide additional functions of the printing device or related devices without adding additional motors.

In some examples, the printing device 100 may include a print zone. The print zone may be utilized to deposit a print substance on a print medium. In some examples, the print zone of the printing device 100 may include a carriage 102. As used herein, “carriage” refers to a compartment of a printing device that houses and transports print substance containers, printheads, or other components of the printing device 100. In some examples, the carriage 102 may travel back and forth across the print zone. For example, the carriage 102 may transition between a first position and a second position. In some examples, the carriage 102 may hold a page-wide print head and transition to perform maintenance actions or other functions of the printing device 100.

In some examples, the carriage 102 may slide along a gate shifter 104 to transition between a first position and a second position. That is, the carriage 102 may slide or transition towards a first end 107 of the gate shifter 104 to arrive at a first position. In addition, the carriage 102 may slide or transition towards a second end 109 of the gate shifter 104 to arrive at a second position. As used herein, “gate shifter” refers to a component of the printing device that transitions as the carriage transitions and creates an opening.

In some examples, a first motor 101 may cause the carriage 102 to transition between a first position and a second position. In some examples, the first motor 101 may be located in the compartment that holds the carriage 102. However, this disclosure is not so limited. For example, the first motor 101 may be located in other portions of the printing device 100. That is, the first motor 101 may be located in a portion of the printing device 100 that allows the first motor 101 to transition the carriage 102 between a first position and a second position. In some examples, the first motor 101 may cause the carriage 102 to move or transition a gate shifter 104.

That is, the carriage 102 may exert a force on the gate shifter 104 as the carriage 102 transitions between the first position and the second position. In some examples, the carriage 102 may cause the gate shifter 104 to transition between an open position and a closed position as the carriage 102 transitions between the first position and the second position. The gate shifter 104 may move in the direction towards the first end 107 of the gate shifter 104 to transition into an open position. In contrast, the gate shifter 104 may move in the direction towards the second end 109 of the gate shifter 104 to transition into a closed position.

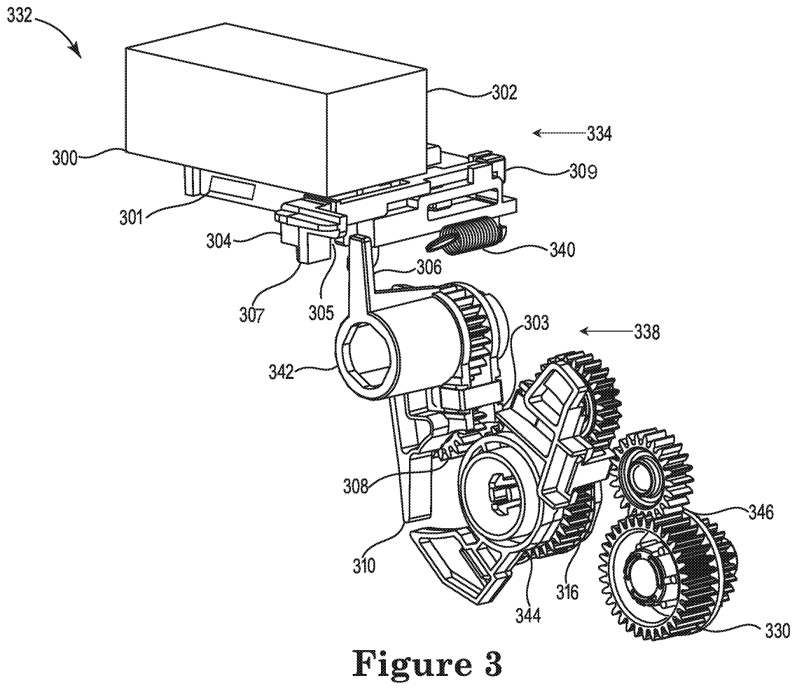

For instance, as the carriage 102 transitions into a first position, the carriage 102 may exert a force on the gate shifter 104 causing the gate shifter 104 to travel in the same direction as the carriage 102, while the gate shifter wall 111 remains in place. That is, both the carriage 102 and the gate shifter 104 may travel towards a first end 107 of the gate shifter 104 to transition the gate shifter 104 into an open position. In some examples, the gate shifter 104 may produce an opening (e.g., opening 305 of FIG. 3) when the gate shifter 104 is in an open position.

Conversely, as the carriage 102 transitions into a second position, the carriage 102 may exert a force on the gate shifter 104 causing the gate shifter 104 to travel in the same direction as the carriage 102, while the gate shifter wall 111 remains in place. That is, the carriage 102 and the gate shifter 104 may travel towards a second end 109 of the gate shifter 104 to transition the gate shifter 104 into a closed position. For instance, the gate shifter 104 may close the opening as the gate shifter 104 transitions towards the second end 109 of the gate shifter 104. In some example, the gate shifter 104 may be in a closed position when the opening is closed.

In some examples, the printing device 100 may include a feed swing arm 106. The feed swingarm 106 may be connected to a feed component (e,g., feed component 342 of FIG. 3). As used herein, “feed component” refers to the component of the printing device that comprises the feed swingarm and the feed swing and enables the pick mechanism when in an active position. It should be understood that when an element is referred to as being “connected to” or “in contact with” another element, it may be directly connected, or in contact with the other element or intervening elements may be present. As used herein, “feed swingarm” refers to an arm connected to the feed component that interacts with a carriage mechanism. The feed swingarm 106 may transition between a first side of the gate shifter 104 and a second side of the gate shifter 104 when the gate shifter 104 is in an open position. The feed swingarm 106 may transition from a first side of the gate shifter 104 to the second side of the gate shifter 104 by moving through an opening in the gate shifter 104 and to a second side of the gate shifter 104. In addition, the feed swingarm 106 may transition from a second side of the gate shifter 104 to the first side of the gate shifter 104 by moving through an opening in the gate shifter 104.

In some examples, the printing device 100 may utilize a first motor 101 to actuate a carriage 102 and a gate shifter 104. For instance, the first motor 101 may actuate the carriage 102 which in turn may actuate the gate shifter 104 to allow the feed swingarm 106 to transition between a first side and a second side of the gate shifter 104. That is, the first motor 101 may actuate a plurality of components (e.g., the carriage 102 and the gate shifter 104) of the printing device 100.

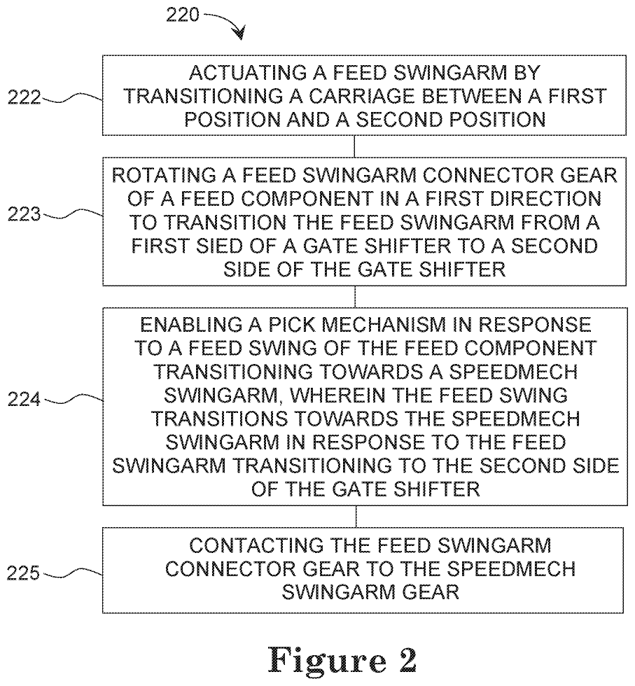

FIG. 2 is an example method 220 for a carriage activated printing device consistent with the present disclosure, Method 220 may be performed, for example, by a controller of a printing device (e.g., printing device 100, described in FIG. 1). In some examples, the method 220 may be performed with more or less elements. As used herein, “controller” refers to a component of the printing device that receives data to perform a print job and initiates hardware to perform the print job. The controller may be a hardware processing unit such as a microprocessor, application specific instruction set processor, coprocessor, network processor, or similar hardware circuitry that may cause machine-readable instructions to be executed. In some examples, the controller may be a plurality of hardware processing units that may cause machine-readable instructions to be executed. The controller may include central processing units (CPUs) among other types of processing units. The controller may also include dedicated circuits or state machines, such as in an Application Specific Integrated Circuit (ASIC), Field Programmable Gate Array (FPGA) or similar design-specific hardware. In some examples, the controller may be a part of the printing device. However, this disclosure is not so limited. For example, the controller may be remote to the printing device such as a wired or wireless network.

At 222, the method 220 may include actuating a feed swingarm by transitioning a carriage between a first position and a second position. In some examples, a first motor may cause a carriage to actuate and transition the carriage into a first position. When the carriage transitions into a first position it may exert a force on the gate shifter causing the gate shifter to transition into an open position. In some examples, the gate shifter may create an opening (e.g., opening 305 of FIG. 3) when in an open position. In addition, a feed swingarm may transition through the opening after the carriage transition into a first position and the gate shifter transitions into an open position. As used herein, “actuate” refers to the act of causing a device or component to activate or operate as intended. In some examples, a second motor may actuate and cause a feed swingarm to actuate. That is, the feed swingarm may actuate by transitioning between the first side and the second side of the gate shifter when the gate shifter is in an open position.

At 223, the method 220 may include rotating a feed swingarm connector gear of a feed component in a first direction to transition the feed swingarm from a first side of a gate shifter to a second side of the gate shifter. In some examples, the feed swingarm may transition between a first side of a gate shifter and a second side of the gate shifter when the gate shifter is in an open position. For instance, the feed swingarm connector gear may rotate in a first direction to actuate the feed swingarm and cause the feed swingarm to transition from a first side of the gate shifter to the second side of the gate shifter. That is, the feed swingarm connector gear may rotate in a first direction to cause the feed swingarm to move through an opening in the gate shifter and to the second side of the gate shifter. In some examples, the feed swingarm is actuated when the feed swingarm transition between a first side of the gate shifter to a second side of the gate shifter. As used herein, “feed swingarm connector gear” refers to a toothed wheel of the feed component that rotates in a first direction and a second direction and may contact other gears (e.g., the speedmech swingarm gear) as it rotates.

At 224, the method 220 may include enabling a pick mechanism in response to a feed swing of the feed component transitioning towards a speedmech swingarm, wherein the feed swing transitions towards the speedmech swingarm in response to the feed swingarm transitioning to the second side of the gate shifter. As used herein, “feed swing” refers to an arm connected to the feed component that interacts with the speedmech swingarm. As used herein, “pick mechanism” refers to the component of the printing device that grabs or picks the print media that will be used during the printing process. As used herein, “speedmech swingarm” refers to a component of the printing device that includes the speedmech swingarm gear and the speedmech swingarm connector gear and connects the gears of the feed component to the gears of the pick mechanism.

In some examples, as the feed swingarm of the feed component transitions to a second side of the gate shifter the feed swing may transition towards a speedmech swingarm. That is, the pick mechanism may be enabled as the feed component changes positions. As used herein, “enable” refers to the act of causing a device or component to be operational. For example, when the pick mechanism is enabled it may be able to operate as intended and perform its function. As used herein, “disable” refers to the act of causing a device or component to be inoperable. For example, when the pick mechanism is disabled it temporarily may not be able to perform its intended function.

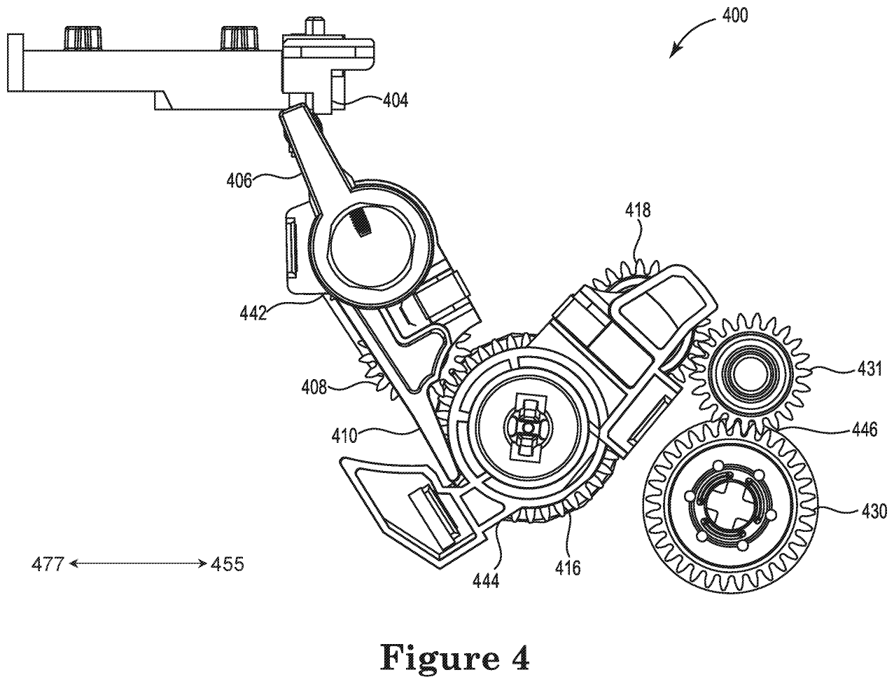

For instance, as the feed swingarm connector gear rotates in a first direction, the feed swingarm may move to a second side of the gate shifter. In addition, the feed swing may transition towards the speedmech swingarm as the feed swingarm transition to the second side of the gate shifter. The speedmech swingarm may lock the feed swing in position by transitioning the speedmech swingarm towards the gate shifter. In some examples, the gate shifter may transition into a closed position before the speedmech swingarm locks the feed swing into position. That is, the pick mechanism may be enabled by the speedmech swingarm locking the feed component into an active position when the gate shifter is in a closed position and the feed swingarm is on the second side of the gate shifter, as shown in FIG. 4. In some examples, when the feed component is locked into an active position the feed swingarm is locked to the second side of the gate shifter and the feed swing is positioned between the speedmech swingarm gear and the speedmech swingarm. As used herein, “active position” refers to a position of the feed component that enables the pick mechanism. As used herein, “passive position” refers to a position of the feed component that disables the pick mechanism.

At 225, the method 220 may include contacting the feed swingarm connector gear to the speedmech swingarm gear. In some examples, the feed swingarm connector gear may contact the speedmech swingarm gear when the feed component is locked into an active position. In some examples, when the feed swing contacts the speedmech swingarm the feed swingarm connector gear may be in contact with the speedmech swingarm gear. As used herein, “speedmech swingarm gear” refers to a toothed wheel connected to the speedmech swingarm that is in constant contact with the speedmech swingarm connector gear as it rotates in a first direction and a second direction and may contact other gears (e.g., the feed swingarm connector gear) as it rotates.

In some examples, the feed component may be locked into the active position when the feed swingarm connector gear is in contact with the speedmech swingarm gear. In some examples, the feed swingarm connector gear may be in contact with the pick drive gear of the pick mechanism. For instance, the feed swingarm connector gear may be indirectly connected to the pick drive gear through the speedmech swingarm. For example, when the feed component is in an active position the feed component may be connected to the speedmech swingarm which may be connected to the pick mechanism. In some examples, connecting the feed component to the pick mechanism through the speedmech swingarm may enable the pick mechanism. That is, connecting the feed component to the speedmech swingarm and connecting the speedmech swingarm to the pick mechanism may allow the pick drive gear of the pick mechanism to rotate as the feed swingarm connector gear of the feed component rotates. As used herein, “pick drive gear” refers to a toothed wheel of the pick mechanism that is in constant contact with the idler gear and may be enabled by the feed component.

The printing device may include a first motor to actuate the carriage and the gate shifter. In addition, the printing device may include a second motor to actuate a feed component, a speedmech swingarm, and a pick mechanism. That is, once the gate shifter is in an open position, the second motor may cause the feed swingarm of the feed component to transition to the second side of the gate shifter to transition the feed component into an active position. When the feed component is in an active position, the feed component, the speedmech swingarm, and the pick mechanism are connected to each other which may allow the second motor to actuate the pick mechanism. In some examples, utilizing one motor (e.g., the second motor) to enable to pick mechanism and the feed component may reduce the size of the printing device as well as the cost of producing the printing device, while maintain the same functionality of the printing device, as compared to printing devices that use separate motors to enable the feed component and the pick mechanism.

FIG. 3 is an example system 332 for a carriage activated printing device 300 in an open position consistent with the present disclosure. The system 332 may include analogous or similar elements as FIG. 1. For example, the system 332 may include a printing device 300 with a first motor 301, a carriage 302, a gate shifter 304, a feed swingarm 306, a first end 307, and a second end 309.

In some examples, the system 332 may be a part of a printing device 300 or utilized by the printing device 300. The printing device 300 may include a carriage mechanism 334. As used herein, “carriage mechanism” refers to a first motor, a carriage, and a gate shifter in a printing device. However, this disclosure is not so limited. In some examples, a “carriage mechanism” may refer to a first motor, a carriage, a gate shifter, and a spring bias in a printing device.

In some examples, the carriage mechanism 334 may comprise a first motor 301, a carriage 302, and a gate shifter 304. In some examples, the first motor 301 may actuate the carriage 302. The carriage 302 may transition between a first position and a second position when actuated by the first motor 301. In some examples, the carriage 302 may exert a force on a gate shifter 304 to transition the gate shifter 304 between an open position and a closed position.

For instance, when the carriage 302 transitions into a first position, the carriage 302 may exert a force on the gate shifter 304 causing the gate shifter 304 to move in the same direction as the carriage 302. For instance, the carriage 302 and the gate shifter 304 may transition towards the first end 307 of the gate shifter 304 to create an opening 305 in the gate shifter 304. In addition, when the carriage 302 transitions into a second position the carriage 302 may exert a force on the gate shifter 304 causing the gate shifter 304 to move in the same direction as the carriage 302. That is, the carriage 302 and the gate shifter 304 may transition towards the second end 309 of the gate shifter 304 to close the opening 305 in the gate shifter 304.

In some examples, gate shifter 304 may include a spring bias 340. As used herein, “spring bias” refers to a device used to assist the carriage in transitioning the gate shifter into the closed position. In some examples, the spring bias 340 may pull the gate shifter 304 as the carriage 302 exerts a force on the gate shifter. However, this disclosure is not so limited. For example, the gate shifter 304 may transition into a closed position without the use of a spring bias 340. In some examples, the carriage 302 may exert a force directly onto the gate shifter 304 to transition the gate shifter 304 into a closed position.

In some examples, the system 332 may include a feed mechanism 338. In some examples, the feed mechanism 338 may comprise a second motor 303, and a feed component 342 including a feed swing 310, a feed swingarm connector gear 308, and a feed swingarm 306. In some examples, the feed swingarm 306 may transition between a first side of the gate shifter 304 and a second side of the gate shifter 304 when the gate shifter 304 is in an open position. That is, the feed swingarm 306 may go through the opening 305 as it transitions between the first side and the second side of the gate shifter 304. As used herein, “feed mechanism” refers to a second motor and a feed component in a printing device. For example, the feed mechanism may comprise a second motor and the feed swingarm, the feed swing, and the feed swingarm connector gear of the feed component.

In some examples, the feed swingarm connector gear 308 may rotate in a first direction to transition the feed swingarm 306 from a first side of a gate shifter 304 to a second side of a gate shifter 304. In some examples, the system 332 may include a second motor 303. The second motor 303 may cause the feed swingarm connector gear 308 to rotate in a first direction (e.g., clockwise direction) or a second direction (e.g., counter-clockwise direction). In some examples, the second motor 303 may be adjacent to the feed component 342. However, this disclosure is not so limited. For example, the second motor 303 may be located in other portions of the printing device 300.

In some examples, the feed component 342 may comprise a feed swing 310. In some examples, the feed swing 310 may transition as the feed swingarm 306 transitions between a first side of a gate shifter 304 and a second side of a gate shifter 304. That is, the feed component 342 may comprise of a feed swingarm 306, a feed swing 310, and a feed swingarm connector gear 308. As the second motor 303 actuates the feed swingarm connector gear 308, the feed swingarm connector gear 308 may rotate causing the feed swingarm 306 and feed swing 310 to transition.

In some examples, the feed swingarm 306 may transition to the second side of the gate shifter 304 when the feed swing 310 transitions towards the speedmech swingarm 344. The feed component 342 may connect to the speedmech swingarm 344 when the feed swing 310 transition towards the speedmech swingarm 344. In some examples, when the feed component 342 and the speedmech swingarm 344 are connected, the feed swingarm connector gear 308 may contact the speedmech swingarm gear 316. In some examples, when the feed swingarm connector gear 308 is in contact with the speedmech swingarm gear 316, the speedmech swingarm gear 316 may rotate with the feed swingarm connector gear 308 as the feed swingarm connector gear 308 rotates The speedmech swingarm gear 316 may rotate with the feed swingarm connector gear 308 as the feed swingarm connector gear 308 rotates in a first direction. For example, the speedmech swingarm gear 316 may rotate in a second direction (e,g., counter-clockwise direction) as the feed swingarm connector gear 308 rotates in a first direction (e.g., clockwise direction).

In some examples, the feed component 342 may be in an active position when the feed swingarm connector gear 308 is in contact with the speedmech swingarm gear 316. In addition, when the feed component 342 is in an active position, the speedmech swingarm gear 316 may be in contact with the pick mechanism 346. That is, the pick mechanism 346 may be enabled when the feed component 342 is in an active position. In some examples, the pick mechanism 346 may be enabled when the pick drive gear 330 is rotated by the second motor 303. For instance, the second motor 303 may indirectly rotate the pick drive gear of the pick mechanism 346 by rotating the feed swingarm connector gear 308. For example, the second motor 303 may cause the feed swingarm connector gear 308 to rotate in a first direction and when the feed component 342 is in an active position the feed swingarm connector gear 308 may be in contact with the pick mechanism 346. For instance, the feed swingarm connector gear 308 may indirectly contact the pick mechanism 346.

In some examples, when the feed swingarm connector gear 308 is in contact with the speedmech swingarm gear 316 and the speedmech swingarm gear 316 is in contact with the pick drive gear 330 of the pick mechanism 346, the pick drive gear 330 may rotate as the feed swingarm connector gear 308 rotates. That is, when the feed swingarm connector gear 308 is in contact with the speedmech swingarm gear 316 and the speedmech swingarm gear 316 is in contact with the pick drive gear 330, the pick mechanism 346 may be enabled. In some examples, the second motor 303 may actuate the feed component 342, the speedmech swingarm 344, and the pick mechanism 346 by causing the gears of the feed component 342, the speedmech swingarm 344, and the pick mechanism 346 to rotate.

In some examples, the system 332 may include a first motor 301 and a second motor 303 to actuate a carriage 302, a feed component 342, and a pick mechanism 346. For instance, the first motor 301 may transition the carriage 302 between a first position and a second position to cause the gate shifter 304 to transition between an open position and a closed position. When the gate shifter 304 is in an open position a second motor 303 may cause a feed component 342 to transition into an active position which may enable the pick mechanism 346. That is, the second motor 303 may actuate the feed component 342, the speedmech swingarm 344, and the pick mechanism 346. In some examples, utilizing two motors (e.g., the first motor 301 and the second motor 303) to actuate a carriage 302, a feed component 342, and a pick mechanism 346 may maintain the functionality of the printing device 300 while reducing the size of the printing device 300 (e.g., increase performance of the printing device), as compared to printing devices that utilize three or more motors to actuate a carriage, a feed component, and a pick mechanism. In addition, a printing device 300 that utilizes two motors to actuate the carriage 302, the feed component 342, and the pick mechanism 346 may reduce the cost of producing the printing device 300, as compared to printing devices with three or more motors.

FIG. 4 is an example carriage activated printing device 400 in an active position consistent with the present disclosure. Printing device 400 may include analogous or similar elements as FIGS. 1 and 3. For example, printing device 400 may comprise a gate shifter 404, a feed swingarm 406, a feed swing 410, a feed swingarm connector gear 408, a speedmech swingarm gear 416, a pick drive gear 430, a pick mechanism 446, a speedmech swingarm 444, and a feed component 442.

In some examples, the feed swingarm 406 of printing device 400 may transition from a first side to a second side of the gate shifter 404 when the feed swingarm connector gear 408 rotates in a first direction. That is, the feed swingarm 406 may transition in a direction denoted by the arrow 477 to transition from a first side of a gate shifter 404 to a second side of the gate shifter 404. In contrast, the feed swingarm 406 may transition from a second side to a first side of the gate shifter 404 when the feed swingarm connector gear 408 rotates in a second direction. That is, the feed swingarm 406 may transition in a direction denoted by the arrow 455 to transition from the second side of the gate shifter 404 to the first side of the gate shifter 404.

In some examples, the feed swing 410 may transition towards the speedmech swingarm 444 as the feed swingarm 406 transitions to a second side of the gate shifter 404. For instance, the feed swing 410 may transition in a direction denoted by the arrow 455 to transition towards the speedmech swingarm 444 as the feed swingarm 406 transitions in a direction denoted by the arrow 477 to transition from a first side of a gate shifter 404 to a second side of the gate shifter 404. In contrast, the feed swing 410 may transition in a direction denoted by the arrow 477 to transition away from the speedmech swingarm 444 as the feed swingarm 406 transitions in a direction denoted by the arrow 455 to transition from the second side of the gate shifter 404 to the first side of the gate shifter 404.

In some examples, the second motor (e.g., second motor 303 of FIG. 3) may cause the feed swingarm connector gear 408 to rotate in a first direction to transition the feed swing 410 in a direction denoted by the arrow 455 as the feed swingarm 406 transitions in a direction denoted by the arrow 477 to transition the feed 442 into an active position. In contrast, the second motor may cause the feed swingarm connector gear 408 to rotate in a second direction to transition the feed swing 410 in a direction denoted by the arrow 477 as the feed swingarm 406 transitions up in a direction denoted by the arrow 455 to transition the feed component 442 into a passive position.

As illustrated in FIG. 4, the feed swing 410 may be positioned between the speedmech swingarm gear 416 and the speedmech swingarm 444 when the feed component 442 is in an active position. That is, the feed swing 410 may move towards the speedmech swingarm 444 to transition the feed component 442 into an active position. In some examples, the feed swingarm connector gear 408 may contact the speedmech swingarm gear 416 when the feed component 442 is in an active position. In some examples, the speedmech swingarm gear 416 may rotate as the feed swingarm connector gear 408 rotates when the feed component 442 is in an active position.

In some examples, the speedmech swingarm 444 may include a speedmech swingarm connector gear 418. As used herein, “speedmech swingarm connector gear” refers to toothed wheel of the speedmech swingarm that is in constant contact with the speedmech swingarm gear as it rotates in a first direction and a second direction and may contact other gears (e.g., the idler gear) as it rotates. The speedmech swingarm connector gear 418 may be connected to the speedmech swingarm gear 416. In some examples, the speedmech swingarm connector gear 418 may rotate as the speedmech swingarm gear 416 rotates. That is, the second motor may cause the feed swingarm connector gear 408, the speedmech swingarm gear 416, and the speedmech swingarm connector gear 418 to rotate substantially simultaneously when the feed component 442 is in an active position. As used herein, “substantially” intends that the characteristic does not have to be absolute but is close enough so as to achieve the characteristic. For example, “substantially simultaneously” is not limited to absolutely simultaneously.

In some examples, the pick mechanism 446 may be enabled when the feed component 442 is in an active position. As illustrated in FIG. 4, the speedmech swingarm connector gear 418 may be in contact with the idler gear 431 of the pick mechanism 446 when the feed component 442 is in an active position. As used herein, “idler gear” refers to a toothed wheel of the pick mechanism that is in constant contact with the pick drive gear as it rotates in a first direction and a second direction and may contact other gears (e.g., the speedmech swingarm connector gear) as it rotates. In some examples, the idler gear 431 may rotate as the speedmech swingarm connector gear 418 rotates when the feed component 442 is in an active position. The idler gear 431 may be connected to the pick drive gear 430 of the pick mechanism 446, In some examples, the pick drive gear 430 may rotate as the idler gear 431 rotates. That is, the second motor may cause the feed swingarm connector gear 408, the speedmech swingarm gear 416, the speedmech swingarm connector gear 418, the idler gear 431, and the pick drive gear 430 to rotate substantially simultaneously when the feed component 442 is in an active position.

In some examples, the pick mechanism 446 may be disabled when the feed component 442 is in a passive position. The feed component 442 may be in a passive position when the feed swingarm 406 is on a first side of the gate shifter 404 and the feed swing 410 is not in contact with the speedmech swingarm 444. In addition, the feed swingarm connector gear 408 may not be in contact with the speedmech swingarm gear 416 and the speedmech swingarm connector gear 418 may not be in contact with the idler gear 431 of the pick mechanism 446, as illustrated in FIG. 3. In some examples, the pick mechanism 446 may be enabled when the speedmech swingarm connector gear 418 is not in contact with the idler gear 431.

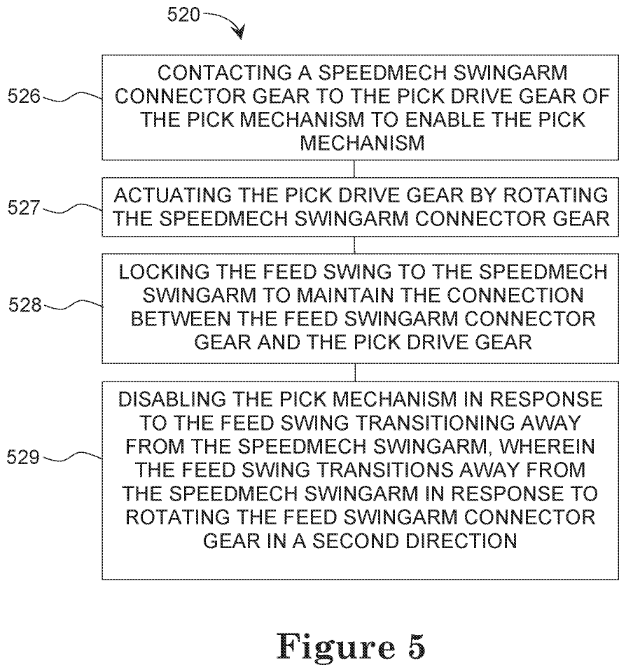

FIG. 5 is an example method 520 for a carriage activated printing device consistent with the present disclosure. Method 520 is analogous or similar to method 220 of FIG. 2. Method 520 may be performed, for example, by a controller of a printing device (e.g., printing device 100, described in FIG. 1). In some examples, the method 520 may be performed with more or less elements.

At 526, the method 520 may include contacting the speedmech swingarm connector gear to the pick drive gear of the pick mechanism to enable the pick mechanism. In some examples, the second motor may cause the feed swingarm connector gear of the feed component to rotate in a first direction. As the feed swingarm connector gear rotates in the first direction the speedmech swingarm may come in contact with the pick mechanism. For example, the second motor may cause the speedmech swingarm connector gear to contact the idler gear of the pick mechanism when the feed component is in an active position. In some examples, the speedmech swingarm connector gear may be connected to the pick drive gear through the idler gear. Likewise, the feed swingarm connector gear may be connected to the pick drive gear through the speedmech swingarm connector gear.

At 527, the method 520 may include actuating the pick drive gear by rotating the speedmech swingarm connector gear. The feed swingarm connector gear of the feed component may be in contact with the speedmech swingarm gear when the feed component is in an active position. In some examples, a second motor may cause the feed swingarm connector gear to rotate in a first direction to transition the feed swingarm connector gear into an active position. When the feed component is in an active position, the feed swingarm connector gear may cause the speedmech swingarm gear to rotate with the feed swingarm connector gear.

In some examples, the speedmech swingarm gear may be connected to and in contact with the speedmech swingarm connector gear. The connection between the speedmech swingarm gear and the speedmech swingarm connector gear may cause the speedmech swingarm connector gear to rotate as the speedmech swingarm gear rotates. In addition, when the feed component is in an active position, the speedmech swingarm connector gear may be in contact with the pick mechanism.

For instance, the speedmech swingarm connector gear may be in contact with the idler gear which connects to the pick drive gear. In some examples, the speedmech swingarm connector gear may cause the idler gear to rotate as the speedmech swingarm connector gear rotates which may actuate the pick drive gear. That is, the second motor may cause the feed swingarm connector gear to rotate in a first direction which may cause the pick drive gear to rotate and actuate.

At 528, the method 520 may include locking the feed swing to the speedmech swingarm to maintain a connection between the feed swingarm connector gear and the pick drive gear. In some examples, the feed swing may be locked between the speedmech swingarm gear and the speedmech swingarm, as illustrated in FIG. 4. That is, the feed swing of the feed component may not be able to change positions until the speedmech swingarm releases the feed swing of the feed component. In some examples, the speedmech swingarm may release the feed swing by transitioning the speedmech swingarm gear towards the pick mechanism. In some examples, locking the feed swing to the speedmech swingarm may maintain the connection between the feed swingarm connector gear and the pick drive gear of the pick mechanism.

At 529, the method 520 may include disabling the pick mechanism in response to the feed swing transitioning away from the speedmech swingarm, wherein the feed swing transitions away from the speedmech swingarm in response to rotating the feed swingarm connector gear in a second direction. In some examples, the pick mechanism may be disabled when the feed component transition into a passive position. The feed component may transition into a passive position when the speedmech swingarm releases the feed swing by transitioning the speedmech swingarm gear towards the pick mechanism. That is, once the speedmech swingarm transitions towards the pick mechanism the speedmech swingarm connector gear transitions away from the idler gear of the pick mechanism. In addition, the feed component may change positions causing the feed swingarm to transition to a first side of the gate shifter and the feed swing to transition away from the speedmech swingarm.

The figures herein follow a numbering convention in which the first digit corresponds to the drawing figure number and the remaining digits identify an element or component in the drawing. Elements shown in the various figures herein may be capable of being added, exchanged, or eliminated so as to provide a number of additional examples of the disclosure. In addition, the proportion and the relative scale of the elements provided in the figures are intended to illustrate the examples of the disclosure and should not be taken in a limiting sense.

It should be understood that the descriptions of various examples may not be drawn to scale and thus, the descriptions may have a different size and/or configuration other than as shown therein.

What is claimed:

1. A printing device comprising:
a first motor to transition a carriage between a first position and a second position;
the carriage to exert a force on a gate shifter as the carriage transitions between the first position and the second position;
the gate shifter to transition between an open position and a closed position in response to the exerted force of the carriage; and
a feed swingarm to transition between a first side and a second side of the gate shifter when the gate shifter is in the open position.

2. The printing device of claim 1, further comprising a second motor to rotate a feed swingarm connector gear in a first direction and a second direction, wherein the rotation transitions the feed swingarm between the first side and the second side of the gate shifter.

3. The printing device of claim 2, further comprising a feed component to enable a pick mechanism when the feed swingarm is on the second side of the gate shifter and disable the pick mechanism when the feed swingarm is on the first side of the gate shifter.

4. The printing device of claim 1, wherein the gate shifter is to prevent the transition of the feed swingarm when the gate shifter is in the closed position.

5. The printing device of claim 1, further comprising a spring bias to assist the carriage in transitioning the gate shifter between the open position and the closed position.

6. A method comprising:
actuating a feed swingarm by transitioning a carriage between a first position and a second position;
rotating a feed swingarm connector gear of a feed component in a first direction to transition the feed swingarm from a first side of a gate shifter to a second side of the gate shifter;
enabling a pick mechanism in response to a feed swing of the feed component transitioning towards a speedmech swingarm, wherein the feed swing transitions towards the speedmech swingarm in response to the feed swingarm transitioning to the second side of the gate shifter; and
contacting the feed swingarm connector gear to a speedmech swingarm gear of the speedmech swingarm.

7. The method of claim 6, further comprising contacting a speedmech swingarm connector gear of the speedmech swingarm to a pick drive gear of the pick mechanism to enable the pick mechanism.

8. The method of claim 7, further comprising actuating the pick drive gear by rotating the speedmech swingarm connector gear.

9. The method of claim 7, further comprising locking the feed swing to the speedmech swingarm to maintain a connection between the feed swingarm connector gear and the pick drive gear.

10. The method of claim 6, further comprising disabling the pick mechanism in response to the feed swing transitioning away from the speedmech swingarm, wherein the feed swing transitions away from the speedmech swingarm in response to rotating the feed swingarm connector gear in a second direction.

11. The method of claim 6, further comprising actuating a first motor to transition the carriage between the first position and the second position.

12. A printing system comprising:
a carriage mechanism including:
a first motor to transition a carriage between a first position and a second position; and
a gate shifter to transition between an open position and a closed position, wherein the gate shifter transitions into the open position when the carriage is in the first position and transitions into the closed position when the carriage is in the second position; and
a feed mechanism including:
a second motor to rotate a feed swingarm connector gear in a first direction and a second direction;
a feed swingarm to transition between a first side and a second side of the gate shifter as the feed swingarm connector gear rotates in the first direction and the second direction; and
the feed swingarm connector gear to contact a pick drive gear of a pick mechanism when the feed swingarm is on the second side of the gate shifter.

13. The printing system of claim 12, wherein the carriage is to exert a force on a gate shifter as it transitions into the first position, wherein the exerted force causes the gate shifter to transition into the open position.

14. The printing system of claim 12, wherein the feed swingarm connector gear is to contact the pick drive gear by contacting a speedmech swingarm connector gear of a speedmech swingarm through the speedmech swingarm gear of the speedmech swingarm.

15. The printing system of claim 14, wherein the feed mechanism further comprises a feed swing to transition towards the speedmech swingarm in response to the feed swingarm transitioning to the second side of the gate shifter.
